(19) United States
(12) Patent Application Publication
(10) Pub. No.: US 2026/0168662 A1
(43) Pub. Date: Jun. 18, 2026

(54) CONNECTING TERMINAL ASSEMBLY FOR A GROW LIGHT AND GROW LIGHT MECHANISM

(71) Applicant: Sinowell (Shanghai) Co., Ltd., Shanghai (CN)

(72) Inventors: Jia LUO, Shanghai (CN); Yunfei DUAN, Shanghai (CN); Liang ZHOU, Shanghai (CN)

(21) Appl. No.: 19/217,550

(22) Filed: May 23, 2025

(30) Foreign Application Priority Data
Dec. 13, 2024 (CN) 202423103372.5

(51) Int. Cl. F21V 23/06; F21S 8/00; F21Y 103/00; H01R 13/504; H01R 13/52; H01R 13/629; H01R 24/68; H01R 24/76; H01R 103/00

(52) U.S. Cl. CPC F21V 23/06; F21S 8/031; H01R 13/5045; H01R 13/5202; H01R 13/629; H01R 24/68; H01R 24/76; F21Y 2103/00; H01R 2103/00

(57) ABSTRACT

Provided are a connecting terminal assembly for a grow light and a grow light mechanism. The connecting terminal assembly for the grow light includes a main housing, a terminal male end, and a terminal female end. The main housing includes a partition plate, a first shielding edge, and a second shielding edge. The first shielding edge extends toward the vertical line of the partition plate. The second shielding edge protrudes toward the other side of the partition plate facing away from the first shielding edge. The partition plate is provided with a mounting through hole. The terminal male end passes through the mounting through hole, or the extension line of the terminal male end passes through the mounting through hole.

### CROSS-REFERENCE TO RELATED APPLICATION

This application claims priority to Chinese Patent Application No. 202423103372.5 filed Dec. 13, 2024, the disclosure of which is incorporated herein by reference in its entirety.

### TECHNICAL FIELD

The present disclosure relates to the field of lighting devices, particularly a connecting terminal assembly for a grow light and a grow light mechanism.

### BACKGROUND

A grow light is a light used for providing light for plants and usually placed below plant leaves. To facilitate management, plants such as crops are typically planted continuously along a long ridge. To provide lighting for plants in a ridge, multiple grow lights are required to be arranged in sequence along the direction of the ridge.

To improve the stability of the grow lights, an existing light connector is designed such that each of the two ends of the light connector can be fastened to a light tube so that multiple light tubes are connected in sequence in a straight line. The distance between two adjacent light tubes is smaller, reducing gaps in the light and providing better supplementary lighting for the plants.

The defects of the existing light connectors include that they serve only the function of fixed connection, with each light tube still requiring its own power plug and signal transmission terminals. As a result, multiple sockets and signal terminals are required, making the system inconvenient to use and costly.

### SUMMARY

An object of the present disclosure is to provide a connecting terminal assembly for a grow light to solve the problem of limited functionality of existing light connectors. The connecting terminal assembly provided herein is more convenient to use.

To achieve this object, in one aspect, the present disclosure uses the following solution:
The connecting terminal assembly for the grow light includes a main housing, a terminal male end, and a terminal female end. The main housing includes a partition plate, a first shielding edge, and a second shielding edge. The first shielding edge extends toward the vertical line of the partition plate. The second shielding edge protrudes toward the other side of the partition plate facing away from the first shielding edge. The partition plate is provided with a mounting through hole. The terminal male end passes through the mounting through hole, or the extension line of the terminal male end passes through the mounting through hole. The terminal female end passes through the mounting through hole, or the extension line of the terminal female end passes through the mounting through hole. The terminal female end and the terminal male end cooperate to achieve current and/or signal transmission.

In an embodiment, the connecting terminal assembly for the grow light also includes a connecting housing sleeved on and connected to the main housing.

In an embodiment, one of the first shielding edge or the second shielding edge passes through the connecting housing.

In an embodiment, the main housing is in interference fit with the connecting housing.

In an embodiment, the connecting terminal assembly for the grow light also includes at least one shock-absorbing waterproof layer disposed on a side of the main housing and/or the connecting housing facing the light tube.

In an embodiment, the shock-absorbing waterproof layer includes a sheet-shaped waterproof body. An edge of the sheet-shaped waterproof body extends toward the light tube to form a waterproof limiting protruding edge. The sheet-shaped waterproof body is provided with a waterproof mounting through hole for the terminal male end and the terminal female end to pass through.

In an embodiment, the connecting terminal assembly for the grow light also includes a guide member secured to the main housing, and the connecting housing is provided with a housing guide hole for the guide member to pass through.

In an embodiment, the main housing is provided with at least one snap clip for fastening the light tube.

In an embodiment, the terminal male end and/or the terminal female end includes a wire and a support member. The support member is provided with a limiting groove. At least part of the wire passes through the limiting groove.

In another aspect, the present disclosure uses the following solution:
A grow light mechanism includes a light tube and the preceding connecting terminal assembly for the grow light. One end of the connecting terminal assembly is connected to one light tube. The other end of the connecting terminal assembly is connected to one light tube.

The terminal female end and the terminal male end of the connecting terminal assembly for the grow light disclosed by the present disclosure can cooperate to achieve current and/or signal transmission. After two light tubes are connected, two light tubes can share one power source and one signal source, reducing auxiliary devices such as sockets, facilitating use, and incurring lower costs. The user can control the switches and the operating modes of multiple light tubes uniformly, without the need to switch and adjust the operating mode of each light tube individually, resulting in a better user experience.

The grow light mechanism of the present disclosure includes the preceding connecting terminal assembly for the grow light. Two light tubes can be connected to each other by using one connecting terminal assembly, enabling uniform power supply and/or signal transmission, facilitating use, and incurring lower costs.

### BRIEF DESCRIPTION OF DRAWINGS

FIG. 1 is a view of a grow light mechanism according to an embodiment of the present disclosure.

FIG. 2 is an enlarged view of part A of FIG. 1.

FIG. 3 is view one of a connecting terminal assembly according to an embodiment of the present disclosure.

FIG. 4 is view two of a connecting terminal assembly according to an embodiment of the present disclosure.

FIG. 5 is an exploded view of a connecting terminal assembly according to an embodiment of the present disclosure.

FIG. 6 is a view of a main housing according to an embodiment of the present disclosure.

FIG. 7 is an exploded view of a terminal male end and a terminal female end according to an embodiment of the present disclosure.

FIG. 8 is a view of a connecting housing according to an embodiment of the present disclosure.

FIG. 9 is a view of a shock-absorbing waterproof layer according to an embodiment of the present disclosure.

### REFERENCE LIST

1. main housing, 2. terminal male end, 3. terminal female end, 4. connecting housing, 5. shock-absorbing waterproof layer, 6. guide member, 11. first shielding edge, 12. second shielding edge, 13. partition plate, 14. snap clip, 31. wire, 32. support member, 33. limiting groove, 41. housing guide hole, 42. connecting housing through hole, 51. waterproof body, 52. waterproof limiting protruding edge, 53. waterproof mounting through hole, 100. connecting terminal assembly, 131. mounting through hole, 200. light tube

### DETAILED DESCRIPTION

In order that the preceding object, features, and advantages of the present disclosure can be more apparent and easier to understand, embodiments of the present disclosure are described hereinafter in detail in conjunction with drawings. Details are set forth below to facilitate a thorough understanding of the present disclosure. However, the present disclosure can be implemented in many other manners different from those described herein, and those skilled in the art can make similar improvements without departing from the spirit of the present disclosure, so the present disclosure is not limited by embodiments disclosed below.

In the description of the present disclosure, it is to be understood that orientations or position relations indicated by terms such as “center”, “longitudinal”, “lateral”, “length”, “width”, “thickness”, “above”, “below”, “front”, “back”, “left”, “right”, “vertical”, “horizontal”, “top”, “bottom”, “inside”, “outside”, “clockwise”, “counterclockwise”, “axial”, “radial”, and “circumferential” are based on orientations or position relations shown in the drawings. These orientations or position relations are intended only to facilitate the description of the present disclosure and simplify the description and not to indicate or imply that an apparatus or element referred to must have such specific orientations or must be configured or operated in such specific orientations. Thus, these orientations or position relations are not to be construed as limiting the present disclosure.

Moreover, terms such as “first” and “second” are used only for the purpose of description and are not to be construed as indicating or implying relative importance or implicitly indicating the number of technical features indicated. Thus, a feature defined as a “first” feature or a “second” feature may expressly or implicitly include at least one such feature. As used herein, the term “multiple” is defined as at least two, for example, two, three, or the like, unless otherwise specified and limited.

In the present disclosure, unless otherwise expressly specified and limited, the term “installed”, “connected to each other”, “connected”, or “secured” is to be construed in a broad sense, for example, as securely connected, detachably connected, or integrated; mechanically connected or electrically connected; directly connected to each other or indirectly connected to each other via an intermediary; or internally connected between two components or interactional relations between two components. For those of ordinary skill in the art, the meanings of the above terms in the present disclosure can be understood according to specific situations.

In the present disclosure, unless otherwise expressly specified and limited, a first feature “above” or “below” a second feature is to be construed as the first feature directly contacting the second feature, or the first feature indirectly contacting the second feature via an intermediary. Moreover, that the first feature is “above”, “over”, and “on” the second feature may be that the first feature is directly above or obliquely above the second feature or that the level of the first feature is higher than that of the second feature. When the first feature is described as “under”, “below”, or “underneath” the second feature, the first feature is right under, below, or underneath the second feature or the first feature is obliquely under, below, or underneath the second feature, or the first feature is simply at a lower level than the second feature.

It is to be noted that when an element is referred to as being “secured to” or “disposed on” another element, it can be directly on another element or intervening elements may be present. When an element is referred to as being “connected to” another element, it can be directly connected to another element or intervening elements may be present. The terms “vertical”, “horizontal”, “upper”, “lower”, “left”, “right”, and similar expressions used herein are for illustration and not for representing the sole implementation.

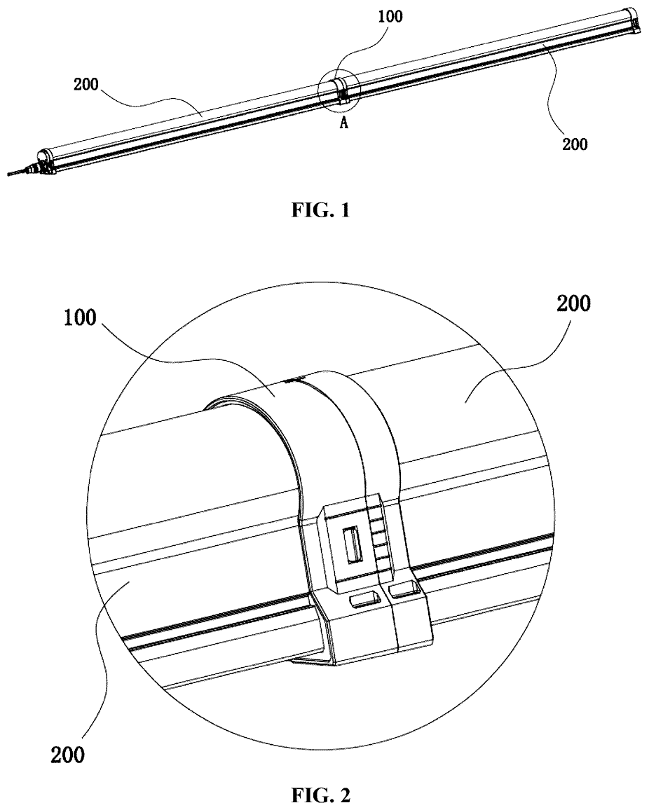

An embodiment provides a connecting terminal assembly for a grow light and a grow light mechanism including the connecting terminal assembly to provide or supplement light to plants. As shown in FIG. 1 and FIG. 2, the grow light mechanism includes a connecting terminal assembly 100 and two light tubes 200. The two ends of the connecting terminal assembly 100 are each connected to one light tube 200.

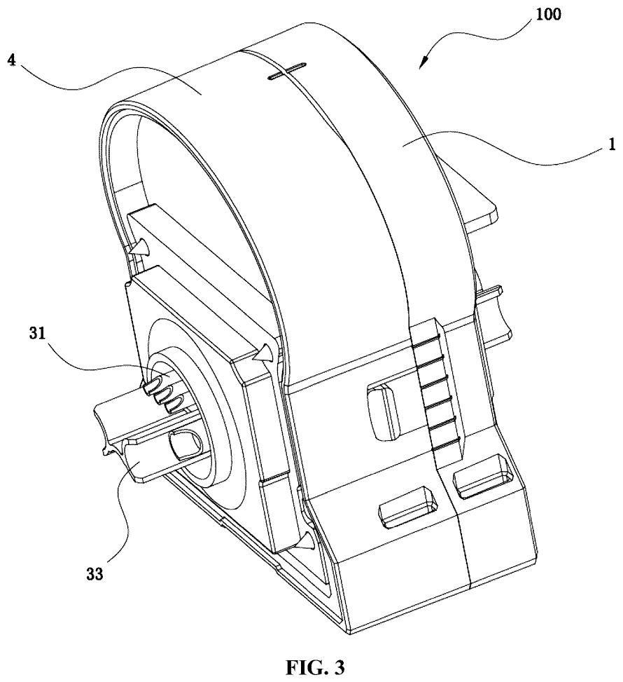

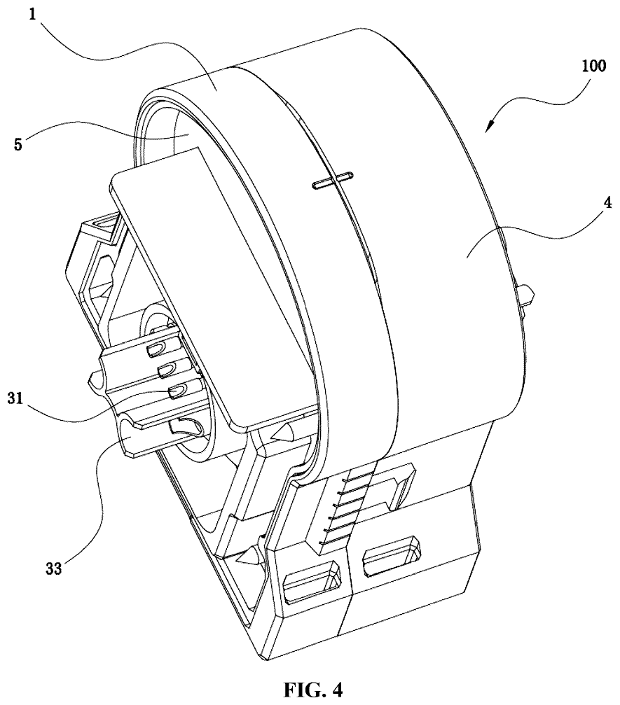

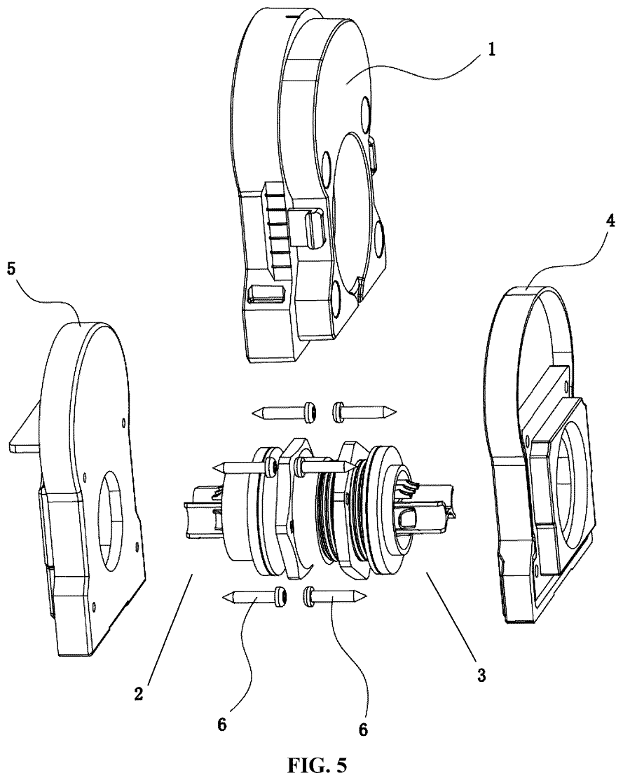

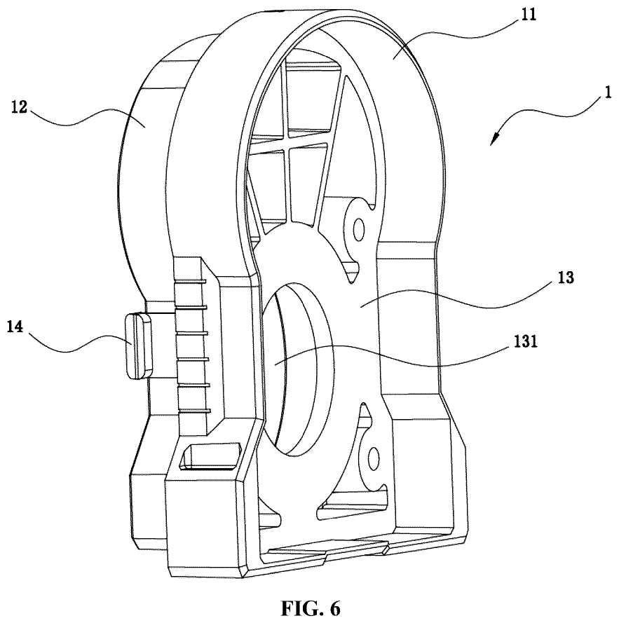

As shown in FIG. 3 to FIG. 6, the connecting terminal assembly 100 of the grow light includes a main housing 1, a terminal male end 2, and a terminal female end 3. The main housing 1 includes a partition plate 13, a first shielding edge 11, and a second shielding edge 12. The first shielding edge 11 extends toward the vertical line of the partition plate 13. The second shielding edge 12 protrudes toward the other side of the partition plate 13 facing away from the first shielding edge 11. The partition plate 13 is provided with a mounting through hole 131. The terminal male end 2 passes through the mounting through hole 131, or the extension line of the terminal male end 2 passes through the mounting through hole 131. The terminal female end 3 passes through the mounting through hole 131, or the extension line of the terminal female end 3 passes through the mounting through hole 131.

The terminal female end 3 and the terminal male end 2 can cooperate to achieve current and/or signal transmission. After two light tubes 200 are connected, the two light tubes 200 can share one power source and one signal source, reducing auxiliary devices such as sockets, facilitating use, and incurring lower costs. The user can control the switches and the operating modes of multiple light tubes 200 uniformly, without the need to switch and adjust the operating mode of each light tube 200 individually, resulting in a better user experience.

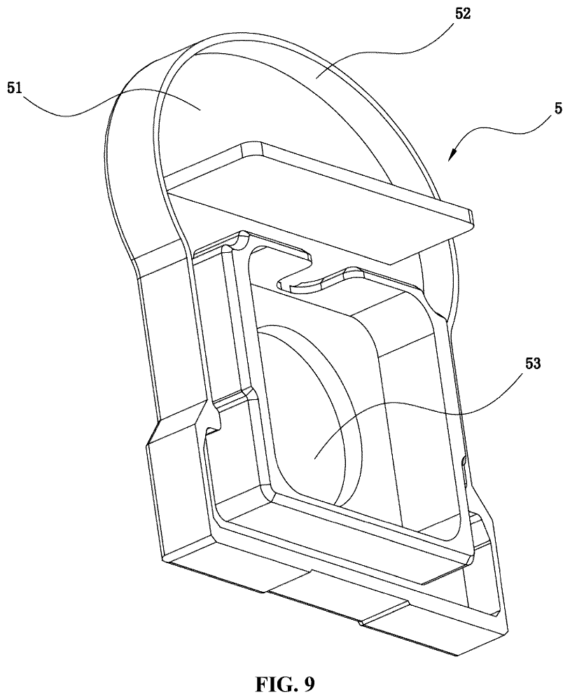

On the basis of the preceding structure, the connecting terminal assembly for the grow light also includes a connecting housing 4 sleeved on and connected to the main housing 1. As shown in FIG. 8, the middle of the connecting housing 4 is provided with a connecting housing through hole 42 for the terminal female end 3 or the terminal male end 2 to pass through, avoiding affecting current and/or signal transmission between two adjacent light tubes 200.

When the connecting terminal assembly 100 includes only the main housing 1, the terminal male end 2, and the terminal female end 3, it is feasible to secure the main housing 1 to an end of one light tube 200 and secure the terminal male end 2 and the terminal female end 3 to the ends of the two light tubes 200 one to one. During assembly, the terminal male end 2 is aligned with the terminal female end 3, then the terminal male end 2 is inserted into the terminal female end 3 to achieve current and/or signal transmission between two adjacent light tubes 200.

After the connecting housing 4 is added, the connecting housing 4 is secured to an end of the other adjacent light tube 200, and during assembly, the connecting housing 4 is inserted into the main housing 1 to ensure that the connection between the terminal male end 2 and the terminal female end 3 is more stable. The combined structure of the connecting housing 4 and the main housing 1 makes the connection between two adjacent light tubes 200 have better sealing performance, prevents impurities and water droplets from entering the connection between two adjacent light tubes 200, and is safer to use.

The connection manner between the connecting housing 4 and the main housing 1 is not limited. In this embodiment, one of the first shielding edge 11 or the second shielding edge 12 passes through the connecting housing 4, facilitating fastening, ensuring a more stable structure after the fastening, and providing good sealing performance.

To improve the aesthetics of the appearance, among the first shielding edge 11 and the second shielding edge 12, the shielding edge passing through the connecting housing 4 has a smaller size, and the other shielding edge has the same shape and size as the connecting housing 4. After assembly, the connecting housing 4 and the main housing 1 form a smooth and neat exterior surface.

To improve the stability of the connection structure, the main housing 1 is in interference fit with the connecting housing 4. During assembly, one of the first shielding edge 11 or the second shielding edge 12 of the main housing 1 penetrates into the connecting housing 4, and the friction force generated by the interference fit can prevent the connecting housing 4 from being separated from the main housing 1, thereby preventing the two adjacent light tubes 200 from being separated and improving the use experience.

On the basis of the preceding structure, as shown in FIG. 3 to FIG. 6, the connecting terminal assembly for the grow light also includes at least one shock-absorbing waterproof layer 5 disposed on the side of the main housing 1 and/or the connecting housing 4 facing the light tube 200. One side of the shock-absorbing waterproof layer 5 abuts the main housing 1 and/or the connecting housing 4, and the other side of the shock-absorbing waterproof layer 5 abuts an end of the light tube 200, avoiding forming a gap at the end of the light tube 200, preventing water vapor from penetrating into the end of the light tube 200, and prolonging the service life of the light tube 200. The shock-absorbing waterproof layer 5 ensures a more stable connection at the end of the light tube 200, preventing the light tube 200 from wobbling.

The structure of the shock-absorbing waterproof layer 5 is not limited as long as the shock-absorbing waterproof layer 5 has shock-absorbing and waterproof functions. As shown in FIG. 9, the shock-absorbing waterproof layer 5 includes a sheet-shaped waterproof body 51. An edge of the waterproof body 51 extends toward the light tube 200 to form a waterproof limiting protruding edge 52, ensuring that the end of the light tube 200 has good sealing performance. The waterproof body 51 is provided with a waterproof mounting through hole 53 for the terminal male end 2 and the terminal female end 3 to pass through, not hindering the normal mounting of the terminal male end 2 and the terminal female end 3.

To improve the stability of the connection between two adjacent light tubes 200, as shown in FIGS. 3 to 6, the main housing 1 is provided with at least one snap clip 14, and the light tube 200 is provided with a fastening hole. During assembly, the snap clip 14 of the main housing 1 located on one light tube 200 is inserted into the fastening hole on the other light tube 200, achieving the fastening of two adjacent light tubes 200 and ensuring a high assembly efficiency. During disassembly, two adjacent light tubes 200 can be separated as long as the snap clip 14 is removed from the fastening hole by being pressed or in other manners.

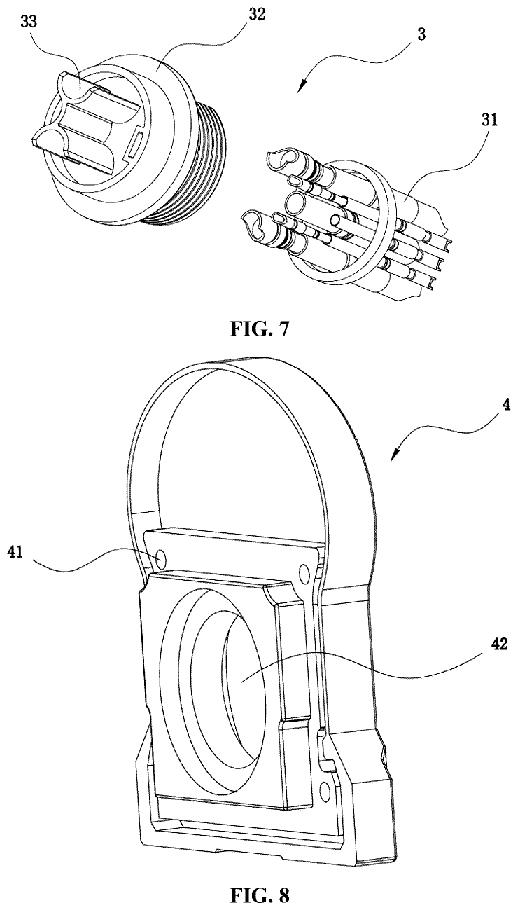

The terminal male end 2 and the terminal female end 3 may have a structure that is not limited or have a terminal structure of the related art. In this embodiment, as shown in FIG. 7, the terminal male end 2 and/or the terminal female end 3 includes wires 31 and a support member 32. The support member 32 is provided with limiting grooves 33. At least part of the wires 31 pass through the limiting grooves 33. The limiting grooves 33 can isolate different wires 31. For example, wires for transmitting strong electricity are placed in one limiting groove 33, and wires for transmitting signals are placed in other limiting grooves 33. Wires 31 for different purposes are not mixed together to avoid mutual interference.

As shown in FIG. 5 and FIG. 8, the connecting terminal assembly for the grow light also includes a guide member 6 secured to the main housing 1, and the connecting housing 4 is provided with a housing guide hole 41 for the guide member 6 to pass through. During assembly, when the guide member 6 is aligned with the housing guide hole 41, the terminal male end 2 and the terminal female end 3 are substantially aligned. The two light tubes 200 are pushed relative to each other, and the guide member 6 passes through the housing guide hole 41, until the terminal male end 2 is docked with the terminal female end 3, ensuring a high assembly efficiency.

It is to be noted that the preceding are preferred embodiments of the present disclosure and technical principles used therein. It is to be understood by those skilled in the art that the present disclosure is not limited to the embodiments described herein. Those skilled in the art can make various apparent changes, modifications, and substitutions without departing from the scope of the present disclosure. Therefore, while the present disclosure is described in detail in conjunction with the preceding embodiments, the present disclosure is not limited to the preceding embodiments and may include equivalent embodiments without departing from the concept of the present disclosure. The scope of the present disclosure is determined by the scope of the appended claims.

What is claimed is:

1. A connecting terminal assembly for a grow light, comprising:
a main housing, comprising a partition plate, a first shielding edge, and a second shielding edge, wherein the first shielding edge extends toward a vertical line of the partition plate, the second shielding edge protrudes toward another side of the partition plate facing away from the first shielding edge, and the partition plate is provided with a mounting through hole;
a terminal male end, the terminal male end passing through the mounting through hole or an extension line of the terminal male end passing through the mounting through hole; and
a terminal female end, the terminal female end passing through the mounting through hole or an extension line of the terminal female end passing through the mounting through hole, wherein the terminal female end and the terminal male end cooperate to achieve at least one of current transmission or signal transmission.

2. The connecting terminal assembly for the grow light according to claim 1, further comprising: a connecting housing, wherein the connecting housing is sleeved on and connected to the main housing.

3. The connecting terminal assembly for the grow light according to claim 2, wherein one of the first shielding edge or the second shielding edge passes through the connecting housing.

4. The connecting terminal assembly for the grow light according to claim 2, wherein the main housing is in interference fit with the connecting housing.

5. The connecting terminal assembly for the grow light according to claim 2, further comprising: at least one shock-absorbing waterproof layer disposed on at least one of a side of the main housing facing a light tube or a side of the connecting housing facing the light tube.

6. The connecting terminal assembly for the grow light according to claim 5, wherein the shock-absorbing waterproof layer comprises a sheet-shaped waterproof body, an edge of the waterproof body extends toward the lamp tube to form a waterproof limiting protruding edge, and the waterproof body is provided with a waterproof mounting through hole for the terminal male end and the terminal female end to pass through.

7. The connecting terminal assembly for the grow light according to claim 2, further comprising a guide member secured to the main housing, wherein the connecting housing is provided with a housing guide hole for the guide member to pass through.

8. The connecting terminal assembly for the grow light according to claim 1, wherein the main housing is provided with at least one snap clip for fastening the light tube.

9. The connecting terminal assembly for the grow light according to claim 1, wherein at least one of the terminal male end or the terminal female end comprises a wire and a support member, the support member is provided with a limiting groove, and at least part of the wire passes through the limiting groove.

10. A grow light mechanism, comprising a light tube and a connecting terminal assembly for a grow light, wherein one end of the connecting terminal assembly is connected to one light tube, and the other end of the connecting terminal assembly is connected to one light tube;
wherein the connecting terminal assembly comprises:
a main housing, comprising a partition plate, a first shielding edge, and a second shielding edge, wherein the first shielding edge extends toward a vertical line of the partition plate, the second shielding edge protrudes toward another side of the partition plate facing away from the first shielding edge, and the partition plate is provided with a mounting through hole;
a terminal male end, the terminal male end passing through the mounting through hole or an extension line of the terminal male end passing through the mounting through hole; and
a terminal female end, the terminal female end passing through the mounting through hole or an extension line of the terminal female end passing through the mounting through hole, wherein the terminal female end and the terminal male end cooperate to achieve at least one of current transmission or signal transmission.

11. A grow light mechanism, comprising at least two light tubes and a connecting terminal assembly for a grow light,
wherein the connecting terminal assembly comprises:
a main housing, comprising a partition plate, a first shielding edge, and a second shielding edge, wherein the first shielding edge extends toward a vertical line of the partition plate, the second shielding edge protrudes toward another side of the partition plate facing away from the first shielding edge, and the partition plate is provided with a mounting through hole;
a terminal male end, the terminal male end passing through the mounting through hole or an extension line of the terminal male end passing through the mounting through hole; and
a terminal female end, the terminal female end passing through the mounting through hole or an extension line of the terminal female end passing through the mounting through hole, wherein the terminal female end and the terminal male end cooperate to achieve at least one of current transmission or signal transmission;
a connecting housing, wherein the connecting housing is sleeved on and connected to the main housing;
when the grow light mechanism is assembled, the main housing is secured to an end of one of two adjacent light tubes, and the connecting housing is secured to an end of the other one of the two adjacent light tubes, so that the terminal male end and the terminal female end are connected to ends of the two adjacent light tubes respectively.
